(19) United States
(12) Patent Application Publication
(10) Pub. No.: US 2022/0275892 A1
(43) Pub. Date: Sep. 1, 2022

(54) CONNECTOR FOR FLEXIBLE TUBING

(71) Applicant: Global Life Sciences Solutions USA LLC, Mariborough, MA (US)

(72) Inventor: Matthew Sherman, Marlborough, MA (US)

(21) Appl. No.: 17/628,518

(22) PCT Filed: Aug. 5, 2020
(86) PCT No.: PCT/EP2020/071979

§ 371 Date: Jan. 19, 2022

Related U.S. Application Data
(60) Provisional application No. 62/890,102, filed on Aug. 22, 2019.

(51) Int. Cl. F16L 33/22

(52) U.S. Cl. CPC F16L 33/226

(57) ABSTRACT

A connector for flexible tubing, the connector comprising a hollow insert for allowing fluid flow, a first portion of the insert configured to fit inside the tubing, a second portion of the insert, the second portion having external threads, a sleeve configured to engage with the external threads of the second portion of the insert, by means of complementary internal threads, wherein said complementary threads are sized so as to threadingly engage with an outer surface of tubing fitted over said first portion of the insert and at the same time engage with the threads of the second portion of the insert.

### TECHNICAL FIELD

The present invention generally relates to a connector for making connection with flexible tubing. More specifically the present invention relates to a connector which makes leak-resistant connection with one or more flexible tubing, which is particularly useful in the field of bioprocessing.

### BACKGROUND

There are several types of connectors that are used for making connections between various types of tubing. A commonly seen connector with a simple design is one used for joining two pieces of garden hose. Other areas where connectors are used commonly are food industry and plumbing, but these connectors typically have a complex design and are not designed to suit the needs of laboratory environment. With a rise in biotechnological research, the demand for lab equipment which is easy to manufacture, use, clean and sterilize has also increased. Connectors which can be used for the purpose of joining flexible tubing or making connection with another lab equipment are therefore required to meet the above features.

One problem with the connectors disclosed in the prior art is that those connectors are prone to causing fluid leakage or forming dead legs, both of which are undesirable, especially when dealing with manufacturing of biopharmaceuticals or related research. Fluid leakage not only causes reduced final output due to loss of cells or biomolecules in the fluid leaked, but it can also cause contamination. Formation of dead legs further increases the chances of non-uniform cell growth as the spent culture media gets trapped without getting displaced by fresh media. Also, in the bioprocess industry, currently tube to barb connections are used and then a zip-tie is applied to the connection, keeping the tube attached. The zip-tie acts as a pinch point and as the tube relaxes over time, it tends to cause leaks. The zip-ties also require a lot of labor to assemble and are subject to user assembly variation.

One type of connector is disclosed in U.S. Pat. No. 7,100,947B2, which describes a tubing and connector system including a plastic tubing with a helical or spiral outer surface, a lock nut and a connector fitting, wherein the lock nut engages the outer surface of the tubing to squeeze the tubing between the lock nut and the fitting. The problem with such a connector is that the lock nut needs to be manufactured with different thread pitches to engage over tubes which differ in their outer corrugation. Further, most of the tubing used in biomanufacturing is plane tubing without any corrugations, so this type of connector would not be suitable for the intended purpose.

Another type of connector is disclosed in U.S. Pat. No. 9,631,754B2, where a clamp is used to secure the connection between a flexible tube and a tubing connector. This patent mentions that re-tightening of the clamp may be needed due to creep deformation that occurs in some malleable tubing materials that can result in a reduction in the elastic interference created on the connector fitting. This can eventually result in a weaker tubing to fitting joint. Under increased fluid pressure, a weaker radial compression force on the fitting can result in dissociation of the tubing and fitting resulting in a fluid leak.

Yet another type of connector is disclosed in U.S. Pat. No. 7,527,300B2, where the connector comprises a fitting and a collar. The fitting is adapted to receive the flexible tubing thereon and includes an exteriorly disposed barb for engaging the interior walls of the flexible tubing. The collar is adapted to engage the fitting at least about the neck and barb and includes an interiorly disposed flange portion having a contour that is shaped to cooperate with the surfaces of the barb to drive the flexible tubing over the barb and the neck as the collar and fitting are assembled with one another. The tube is thus held over the barb by a friction fit not a mechanical locking and thus prone to dissociation from the fitting.

Thus, there is a need for an improved connector that can provide a leak-resistant connection between a flexible tubing and a connector, and that can be easily manufactured at low cost.

### SUMMARY OF THE INVENTION

The object of the present invention is to provide an improved connector for flexible tubing and a method to form a connection using the connector.

One advantage of the invention is that the connector prevents leakage of fluids at the connection.

Another advantage of the invention is that the connector prevents forming of dead legs in and around the connection.

Another advantage of the invention is that the connector provides a sealing connection with the tubing such that the tubing cannot be pulled out by applying force or get dissociated with the connector under high fluid pressure.

Another advantage of the invention is that the sleeve provides a distributed compressive force encompassing the tubing, removing pitch points and providing significant leak resistance.

Another advantage of the invention is that it provides consistent connector strength, ease of use and short assembly time.

Another advantage of the invention is that it is suitable for single-use although it can be disassembled and reassembled for more than one use.

Another advantage of the invention is that it is particularly useful for amplification of cells in a bioreactor.

According to an aspect of the invention, a connector for flexible tubing comprises a hollow insert for allowing fluid flow, a first portion of the insert configured to fit inside the tubing, a second portion of the insert, the second portion having external threads, a sleeve configured to engage with the external threads of the second portion of the insert by means of complementary internal threads, wherein said complementary threads are sized so as to threadingly engage with an outer surface of tubing fitted over said first portion of the insert and at the same time engage with the threads of the second portion of the insert.

In other aspects of the invention, the minor diameter of the internal threads of the sleeve is less than the outer diameter of the tubing intended to fit the first portion of the insert.

In other aspects of the invention, the mean diameter of the internal threads of the sleeve is approximately equal to or less than the outer diameter of the tubing intended to be connected to the connector, when that tubing is fitted over the first portion of the insert.

In other aspects of the invention, in use the threads of the sleeve deform the tubing to form a complementary thread in the tubing.

In other aspects of the invention, the tubing complementary threads are partially or fully formed.

In other aspects of the invention, in use, the insert is sized to stretch tubing fitted to the first portion of the insert, in order that the outer surface of the tubing is of sufficient diameter to engage with the internal threads of the sleeve to hold the tubing onto the insert, wherein, the sleeve provides compressive force to seal the tubing around the insert.

In other aspects of the invention, the connector is made of plastics or metal material.

In other aspects of the invention, the connector has at least one barb on the first portion of the insert to facilitate its insertion into the tubing.

More advantages and benefits of the present invention will become readily apparent to the person skilled in the art in view of the detailed description below.

### DRAWINGS

The invention will now be described in more detail with reference to the appended drawings, wherein:

FIG. 1 shows an outside view of an exemplary connector of the invention;

FIG. 2 shows a longitudinal section of the connector as illustrated in FIG. 1;

FIG. 3 shows a first top view of a longitudinal section of a connector according to a first embodiment of the invention;

FIG. 4 shows a second top view of the longitudinal section of the connector as illustrated in FIG. 3;

FIG. 5 shows an enlarged view of the connection formed between the tubing and the insert as shown in FIG. 4.

### DETAILED DESCRIPTION

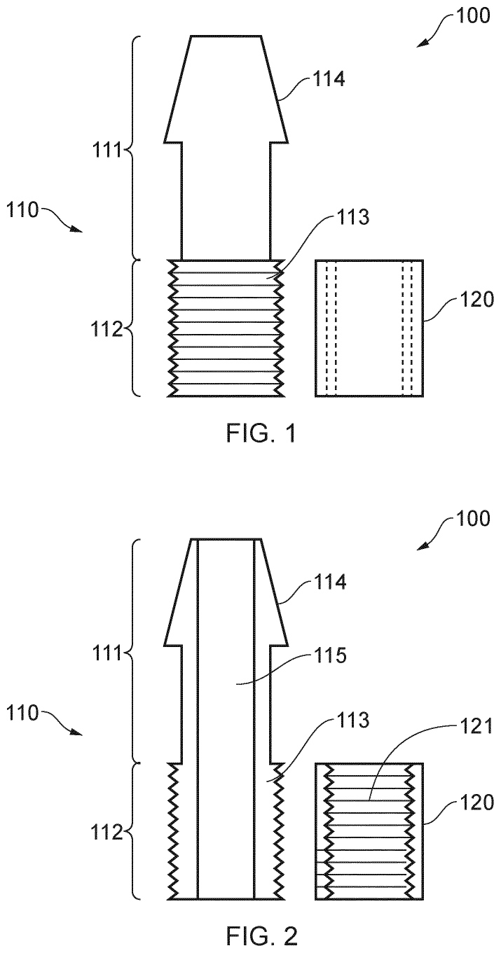

FIG. 1 shows an outside view of an exemplary connector 100 of the invention. The connector 100 comprises a hollow insert 110 for allowing fluid flow, and a sleeve 120. The insert 110 comprises a first portion 111 and a second portion 112. The first portion 111 is configured to fit inside a tubing. In the exemplary connector 100, the first portion 111 comprises a barb 114 to facilitate entry inside the tubing. The second portion 112 comprises external threads 113. The sleeve 120 is configured to engage with the external threads 113 of the second portion 112 of the insert 110.

FIG. 2 shows a longitudinal section of the connector 100 as illustrated in FIG. 1. The connector 100 comprises the hollow insert 110 for allowing fluid flow through a passage 115, and the sleeve 120. The insert 110 comprises the first portion 111 and the second portion 112. The first portion 111 is configured to fit inside a tubing. The second portion 112 comprises external threads 113. The sleeve 120 is configured to engage with the external threads 113 of the second portion 112 of the insert 110. In the exemplary connector 100, the sleeve 120 has internal threads 121 which are complementary to the external threads 113 of the second portion 112 of the insert 110. The complementary threads 121 are sized so as to threadingly engage with an outer surface of tubing fitted over the first portion 111 of the insert 110 and at the same time engage with the threads 113 of the second portion 112 of the insert 110. This provides a kind of mechanical locking of the tubing fitted over the first portion 111 of the insert 110 such that the tubing cannot be pulled out without damaging the tubing or the tubing cannot get dissociated with the insert 110 under high fluid pressure.

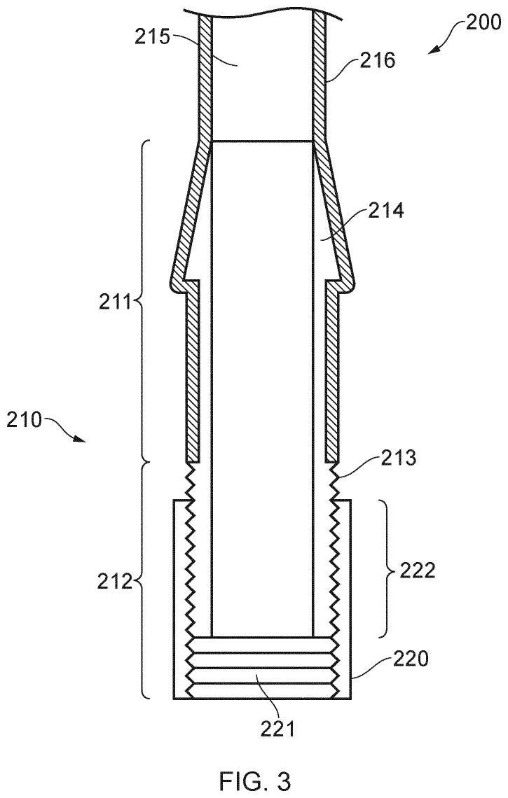

FIG. 3 shows a first top view of a longitudinal section of a connector 200, used with tubing, according to a first embodiment of the invention. The connector 200 comprises a hollow insert 210 for allowing fluid flow through passage 215, and a sleeve 220. The insert 210 comprises a first portion 211 and a second portion 212. The first portion 211 is configured to fit inside a tubing 216. In the connector 200, the first portion 211 of the insert 210 comprises a barb 214 to facilitate entry inside the tubing 216. The second portion 212 comprises external threads 213. The sleeve 220 is configured to engage with the external threads 213 of the second portion 212 of the insert 210. The sleeve 220 has internal threads 221 which are complementary to the external threads 213 on the second portion 212 of the insert 210. The complementary threads 221 are sized so as to threadingly engage with an outer surface of the tubing 216 fitted over the first portion 211 of the insert 210 and at the same time engage with the external threads 213 of the second portion 212 of the insert 210. In FIG. 3, the sleeve 220 is shown to be engaged party with the second portion 212 of the insert 210. Internal threads 221 of a first portion 222 of the sleeve 220 are shown to be engaged with the external threads 213 of the second part 212 of the insert 210. This engagement is achieved by rotating the sleeve 220 over the to second portion 212 towards the first portion 211.

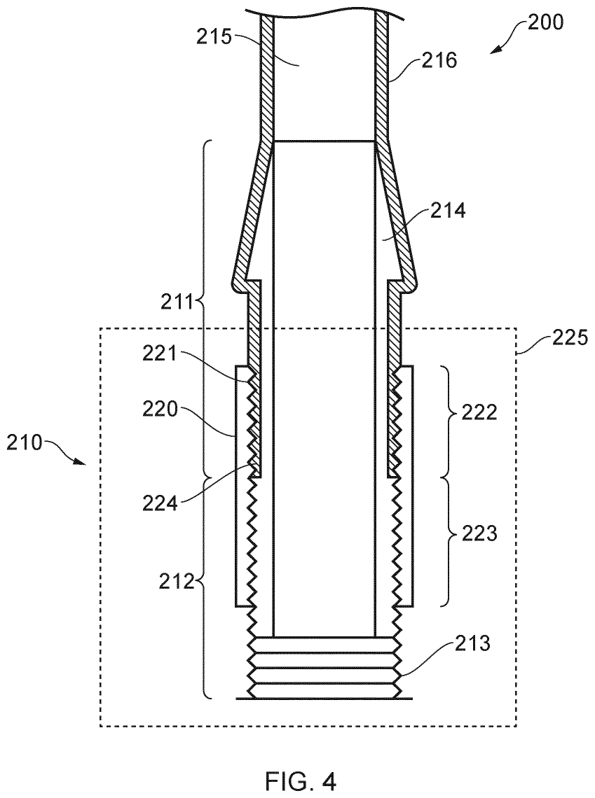

FIG. 4 shows a second top view of the longitudinal section of the connector 200, used with tubing, as illustrated in FIG. 3 in a secured configuration. As shown in FIG. 4, the sleeve 220 is engaged with the second portion 212 of the insert 210 and at the same time engaged with the tubing 216 fitted over the first portion 211 of the insert 210. This double engagement is achieved by further rotating the sleeve 220 such that the sleeve 220 moves towards the first portion 211 thereby moving over the tubing 216 fitted over the first portion 211 of the insert 210. When the sleeve 220 moves over the tubing 216 fitted over the first portion 211, the internal threads 221 of the sleeve 220 deform the tubing 216 to form complementary threads 224 in the tubing 216 to hold the tubing 216 over the insert 210. In FIG. 4, complementary threads 224 are partially formed. In other examples the complementary threads 224 could be fully formed. Compressive force exerted by the sleeve 220 seals the tubing 216 around the insert 210. As can be seen in FIG. 4, the first portion 222 of the sleeve 220 is engaged with the tubing 216 fitted over the first portion 211 of the insert 210 at the same time as a second portion 223 of the sleeve 220 is engaged with the second portion 212 of the insert 210. This causes the tubing 216 to be locked between the insert 210 and first portion 211 securely, thereby preventing accidental pulling out of the tubing 216 or dissociation of the tubing 216 with the insert 210 when there is high pressure fluid flow through the tubing 216.

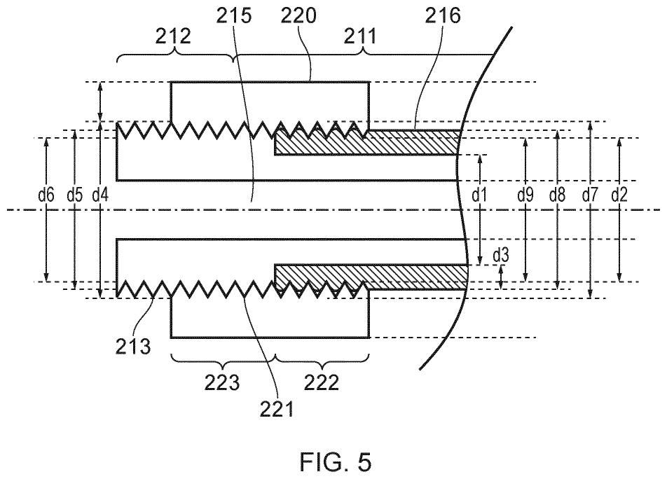

FIG. 5 shows an enlarged view of the connection formed between the tubing 216 and the insert 210, as shown in the box 225 in FIG. 4. The insert 210 comprises the first portion 211, the second portion 212 and the fluid passage 215. The inner diameter of the tubing 216 is shown as d1 and outer diameter of the tubing 216 when the tubing 216 is fitted over the first portion 211 of the insert 210 is shown as d2. Maximum thickness of the tubing 216 is shown as d3. The insert 210 is sized to stretch the tubing 216 fitted to the first portion 211 of the insert 210, in order that the outer surface of the tubing 216 is of sufficient diameter to engage with the internal threads 221 of the sleeve 220 to hold the tubing 216 onto the insert 210, wherein, the sleeve 220 provides compressive force to seal the tubing 216 inside the insert 210. Major diameter, mean diameter and minor diameter of the external threads 213 of the insert 210 are shown as d4, d5 and d6, respectively. Major diameter, mean diameter and minor diameter of the internal threads 221 of the sleeve 220 are shown as d7, d8 and d9 respectively. As the internal threads 221 of the sleeve 220 are complementary to the external threads 213 of the insert 210, major diameter d7, mean diameter d8 and minor diameter d9 of the internal threads 221 of the sleeve 220 are approximately equal to major diameter d4, mean diameter d5 and minor diameter d6 of the external threads 213 of the insert 210 respectively.

To achieve sealing of the tubing 216 around the insert 210, minor diameter d9 of the internal threads 221 of the sleeve 220 is less than the outer diameter d2 of the tubing 216 intended to fit the first portion 211 of the insert 210. Similarly, the mean diameter d8 of the internal threads 221 of the sleeve 220 is approximately equal to or less than the outer diameter d2 of the tubing 216 fitted over the first portion 211 of the insert 210. As shown in FIG. 5, the internal threads 221 of the sleeve 220 have formed complementary partial threads into the thickness d3 of the tubing 216. In other examples, the complementary threads could be fully formed by achieving greater compression of the thickness d3 of the tubing by varying the geometry of the internal threads 221 of the sleeve 220.

In a method of connecting a flexible tubing to a connector of the invention as described above, the method comprises inserting the first portion of the insert into the tubing, rotating the sleeve over the second portion of the insert allowing the complimentary internal threads on the sleeve to engage with the external threads on the second portion of the insert, and further rotating the sleeve towards the first portion of the insert allowing a first portion of the sleeve to rotate over the tubing fitted over the first portion of the insert such that the threads on the sleeve deform the tubing and at the same time a second portion of the sleeve continues to engage with the threads of the second portion of the insert. This results in sealing engagement of the tubing over the insert to provide a leak-resistant connection.

The invention is not to be seen as limited by the embodiments described above, but can be varied within the scope of the appended claims as is readily apparent to the person skilled in the art. For instance, the threads could be based on any of the known standards like Whitworth threads, British Standard Brass (BSB) threads, Model Engineers (ME) threads, Unified and ISO threads, etc. A person skilled in the art could design any suitable geometry of the internal threads of the sleeve and the external threads of the insert so as to achieve a leak-resistant sealing of the tubing over the insert. As would be apparent to a person skilled in the art the depth of deformation of the tubing can be varied based on the geometry of the internal threads of the sleeve. The connector could be made of any suitable material like plastics or metal or a combination of such materials.

1. A connector for flexible tubing, the connector comprising:
a hollow insert configured for allowing fluid flow therethrough, the hollow insert comprising a first portion and a second portion;
wherein the first portion of the insert is configured to fit inside the flexible tubing; and
wherein the second portion of the insert comprises external threads; and
a sleeve comprising complementary internal threads configured to engage with the external threads of the second portion of the insert,
wherein said complementary internal threads are sized so as to threadingly engage with an outer surface of the flexible tubing when the flexile tubing is fitted over said first portion of the insert and at the same time engage with the external threads of the second portion of the insert.

2. The connector of claim 1, wherein a minor diameter of the internal threads of the sleeve is less than an outer diameter of the flexible tubing.

3. The connector of claim 1, wherein a mean diameter of the internal threads of the sleeve is approximately equal to or less than the outer diameter of the flexible tubing, when the flexible tubing is fitted over the first portion of the insert.

4. The connector of claim 1, wherein in use the threads of the sleeve deform the flexible tubing to form a complementary thread in the tubing.

5. The connector of claim 4, wherein said tubing complementary threads are partially or fully formed.

6. The connector of claim 1, wherein, in use, the insert is sized to stretch the flexible tubing to the first portion of the insert such that that the outer surface of the flexible tubing is of sufficient diameter to engage with the internal threads of the sleeve to hold the flexible tubing within the insert, and
wherein the sleeve is configured to provide compressive force to seal the tubing around the insert.

7. The connector of claim 1, wherein the said connector is made of a plastic or metal material.

8. The connector of claim 1, wherein the said connector has at least one barb on the first portion of the insert configured to facilitate insertion into the flexible tubing.

9. A method of connecting a flexible tubing to a connector wherein the connector comprises:
a hollow insert for allowing fluid flow, the hollow insert comprising a first portion and a second portion;
wherein the first portion of the insert is configured to fit inside the tubing; and
wherein the second portion of the insert comprises external threads; and
a sleeve comprising complementary internal threads configured to engage with the external threads of the second portion of the insert;
wherein said complementary threads are sized so as to threadingly engage with an outer surface of the flexible tubing fitted over said first portion of the insert and at the same time engage with the external threads of the second portion of the insert;
wherein the method comprises:
inserting the first portion of the insert into the tubing,
rotating the sleeve over the second portion of the insert allowing the complimentary internal threads on the sleeve to engage with the external threads on the second portion of the insert, and
further rotating the sleeve towards the first portion of the insert allowing a first portion of the sleeve to rotate over the tubing fitted over the first portion of the insert such that the threads on the sleeve deform the tubing and at the same time a second portion of the sleeve continues to engage with the threads of the second portion of the insert to sealingly engage the tubing over the insert.
